(19) United States
(12) Patent Application Publication
(10) Pub. No.: US 2019/0394126 A1
(43) Pub. Date: Dec. 26, 2019

(54) CONTROL DEVICE AND CONTROL METHOD

(71) Applicant: FUJITSU LIMITED, Kawasaki-shi (JP)

(72) Inventor: Katsuhiko Ookubo, Kawasaki (JP)

(73) Assignee: FUJITSU LIMITED, Kawasaki-shi (JP)

(21) Appl. No.: 16/421,542

(22) Filed: May 24, 2019

(30) Foreign Application Priority Data
Jun. 26, 2018 (JP) 2018-120633

(51) Int. Cl. H04L 12/741; H04L 12/947; H04L 29/12

(52) U.S. Cl. CPC H04L 45/745; H04L 61/2007; H04L 49/25

(57) ABSTRACT

A control device includes a processor. The processor is configured to acquire, from a switch, a flow table that includes flow entries each including a match field that defines processing for a packet and includes at least a destination address. The processor is configured to extract a flow entry that is included in the acquired flow table and includes a match field that matches a match field of an entry of matching information stored in advance in a memory. The processor is configured to generate a pseudo packet corresponding to the extracted flow entry. The processor is configured to transmit the generated pseudo packet to the switch.

### CROSS-REFERENCE TO RELATED APPLICATION

This application is based upon and claims the benefit of the prior Japanese Patent Application No. 2018-120633 filed on Jun. 26, 2018, the entire contents of which are incorporated herein by reference.

### FIELD

The embodiments discussed herein are related to a control device and a control method.

### BACKGROUND

In recent years, an open flow (OF: OpenFlow) has attracted attention as one of the software defined network (SDN). The open flow includes an open flow switch (OFS) that performs a data transfer of a network and an open flow controller (OFC) that performs a network routing control. In a communication system which conforms to the open flow, the OFS and the OFC communicate with each other using an open flow protocol.

Upon receipt of a data packet (hereinafter, referred to as a packet), the OFS inquires the OFC about a process on the received packet. The OFC instructs the OFS to perform the process corresponding to the received packet. The OFS performs a process on the received packet (e.g., transferring, discarding, etc.) according to the instruction of the OFC. Hereinafter, an entry that defines a predetermined process to be performed when a packet of a certain condition is received may be referred to as a flow entry.

When receiving a flow entry from the OFC, the OFS may hold (store) flow entry information as a flow table in the memory of its own device. By storing the flow entry in the flow table, the OFS may process the received packet without inquiring of the OFC when receiving a packet corresponding to the stored flow entry.

Related technologies are disclosed in, for example, International Publication Pamphlet No. WO 2013/133400 and Japanese Laid-open Patent Publication No. 2007-208818.

However, when the packet corresponding to (matching) the flow entry stored in the flow table is not received for a certain period of time, the OFS deletes the corresponding flow entry from the flow table. Once the flow entry is deleted, the OFS inquires of the OFC even when the packet corresponding to the corresponding flow entry is received because the OFS does not hold the flow entry. As the OFS processes packets after waiting for a response from the OFC, the transmission of the packet may be delayed. In this case, when the allowable delay time of the packet is relatively small, a communication may not be properly performed.

In the meantime, when the OFS is configured not to delete the flow entry, the OFS requires a huge amount of memory. In addition, when the OFS does not delete the flow entry, the OFC may perform a process which is different from the latest flow entry.

### SUMMARY

According to an aspect of the present invention, provided is a control device including a processor. The processor is configured to acquire, from a switch, a flow table that includes flow entries each including a match field that defines processing for a packet and includes at least a destination address. The processor is configured to extract a flow entry that is included in the acquired flow table and includes a match field that matches a match field of an entry of matching information stored in advance in a memory. The processor is configured to generate a pseudo packet corresponding to the extracted flow entry. The processor is configured to transmit the generated pseudo packet to the switch.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of a communication system 10;

FIG. 2 is a diagram illustrating an example of a sequence of a packet control process;

FIGS. 3A and 3B are diagrams illustrating an example of a flow table possessed by a switch 200;

FIG. 4 is a diagram illustrating a configuration example of a control device 300;

FIG. 5 is a diagram illustrating an example of a matching information table 323;

FIG. 6 is a diagram illustrating an example of a process flowchart of a flow table control process S100;

FIG. 7 is a diagram illustrating an example of a process flowchart of a flow table acquisition process S200;

FIG. 8 is a diagram illustrating an example of a sequence of a flow table acquisition process S200;

FIG. 9 is a diagram illustrating an example of a process flowchart of a matching determination process S300;

FIG. 10 is a diagram illustrating an example of a flow entry extracted in the matching determination process S300;

FIG. 11 is a diagram illustrating an example of a process flowchart of a pseudo packet generation process S400;

FIG. 12 is a diagram illustrating an example of a sequence of a pseudo packet generation process S400;

FIG. 13 is a diagram illustrating a configuration example of a control device 300;

FIG. 14 is a diagram illustrating an example of a continuation determination table 324;

FIG. 15 is a diagram illustrating an example of a process flowchart of a flow table control process S100 according to a second embodiment;

FIG. 16 is a diagram illustrating an example of a process flowchart of a continuation determination process S500; and

FIG. 17 is a diagram illustrating an example of a continuation determination table 324 after execution of the continuation determination process S500.

### DESCRIPTION OF EMBODIMENTS

### First Embodiment

A first embodiment will be described.

<Configuration Example of Communication System>

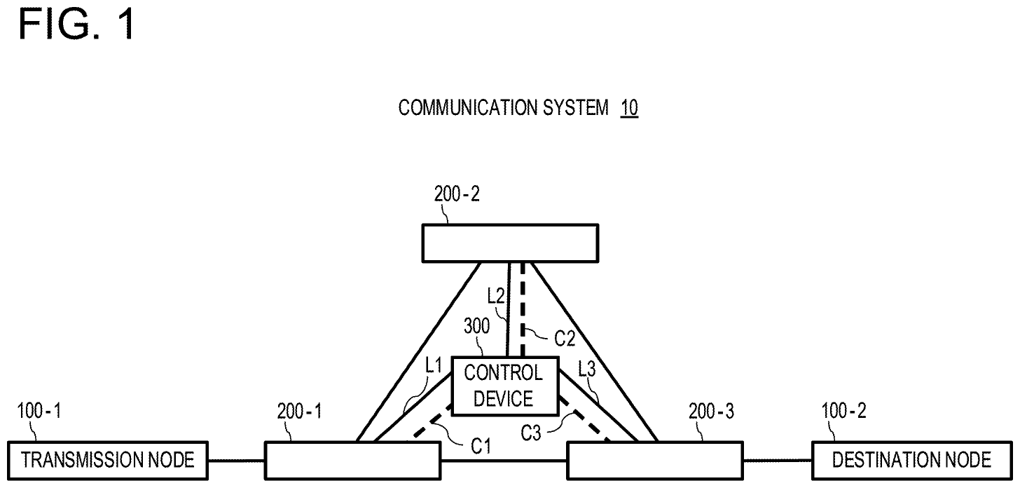

FIG. 1 is a diagram illustrating a configuration example of a communication system 10. The communication system 10 includes communication devices 100-1 and 100-2, switches 200-1 to 200-3, and a control device 300. The communication system 10 is, for example, a communication system that transfers packets including data from a communication device 100-1 serving as a transmission node to a communication device 100-2 serving as a reception node.

The communication devices 100-1 and 100-2 are connected to the switches 200-1 to 200-3, respectively, via a communication cable. The communication cable is, for example, an optical cable. Further, the control device 300 is connected to the switches 200-1 to 200-3 via communication cables L1 to L3, respectively. The communication devices 100-1 and 100-2, the switches 200-1 to 200-3, and the control device 300, respectively, communicate with each other by exchanging packets via communication cables.

Further, the control device 300 is connected to the switches 200-1 to 200-3 via console cables C1 to C3 in order to control the switches 200-1 to 200-3. The control device 300 transmits control commands to the switches 200-1 to 200-3, receives responses of control commands from the switches 200-1 to 300-3, and the like via the console cables C1 to C3. The control device 300 and the switches 200-1 to 200-3 perform a transmission and reception of control commands and responses via the console cables C1 to C3 using, for example, an open flow protocol.

The communication devices 100-1 and 100-2 (hereinafter, may be referred to as a communication device 100) are communication devices such as, for example, a computer and a server. The communication device 100 communicates with each other by exchanging packets including data via a communication cable. Further, the communication device 100 communicates with another communication device 100 via the switches 200-1 to 200-3.

The switches 200-1 to 200-3 (hereinafter, may be referred to as a switch 200) are relay devices that perform a process on the packets received via a communication cable, and are, for example, an OFS. Upon receiving packets via, for example, the communication cable, the switch 200 inquires of the control device 300 about the process of the packets via the console cable. Then, the switch 200 processes the packets according to the response to the inquiry received via the console cable. Further, the response to the inquiry includes, for example, a flow entry.

The control device 300 is a device that responds to an inquiry about the process of packets from the switch 200 received via the console cable and instructs (notifies) the process of the packets to the switch 200 via the console cable, and is, for example, an OFC. The control device 300 determines a flow entry corresponding to the information on the packets (e.g., the type of packet, the transmission source, the transmission destination, etc.) and instructs (notifies) the switch 200.

Further, the switch 200 includes a flow table in the memory of its own device. Upon receiving the flow entry from the control device 300, the switch 200 stores the received flow entry in the flow table. In addition, when the packets received via the communication cable match the flow entry of the flow table, the switch 200 performs a process according to the matched flow entry. In the meantime, when the received packets do not match the flow entry of the flow table, the switch 200 makes an inquiry to the control device 300.

Further, the switch 200 deletes the flow entry of the flow table when a predetermined time has elapsed. In the flow entry deletion method, there is an idle time-out method in which when a packet that matches a flow entry is received within a predetermined time, the measurement of the predetermined time is started over from the beginning. Further, in the flow entry deletion method, regardless of whether the packet that matches the flow entry has been received, there is a hard timeout method of deleting the flow entry when a predetermined time has passed since the flow entry was stored in the flow table. Hereinafter, the switch 200 adopts the idle timeout method as a flow entry deletion method.

When a predetermined condition is satisfied, the control device 300 according to the first embodiment generates a pseudo packet and transmits the pseudo packet on the network. By receiving the pseudo packet that matches the flow entry, the switch 200 restarts the timer that measures the predetermined time until the flow entry is deleted. As a result, inquiries for the packet that matches the flow entry are suppressed, and a communication delay of the packet corresponding to the flow entry is suppressed.

<Packet Control Process>

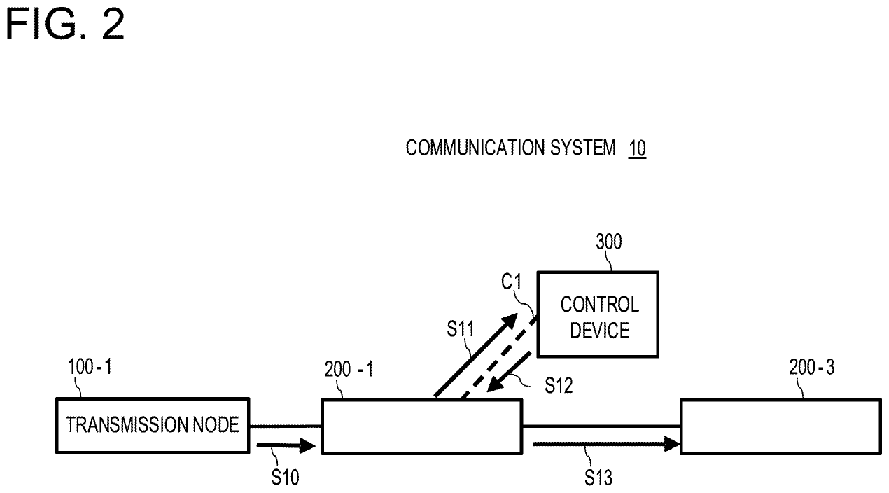

FIG. 2 is a diagram illustrating an example of a sequence of a packet control process. The communication device 100-1 transmits, for example, a packet to be transmitted to the communication device 100-2 to the switch 200-1 serving as a relay device (S10).

When the received packet matches the flow entry of the flow table of its own device, the switch 200-1 processes the matched flow entry. Here, descriptions will be made on a case where the received packet does not match the flow entry of the flow table of its own device.

When the received packet does not match the flow entry of the flow table of its own device, the switch 200-1 inquires of the control device 300 about the process for the packet via a console cable C1 (S11). For example, this inquiry is a packet-in in an open flow communication system.

Upon receiving the inquiry, the control device 300 detects a flow entry for the packet from, for example, the flow table of its own device, and responds to the inquiring source switch 200-1 via the console cable C1 (S12). For example, this response is a packet-out in the open flow communication system.

The switch 200-1 stores the received flow entry in the flow table of its own device, and performs a process according to the flow entry. A process according to the flow entry means, for example, a process of transmitting the received packet to a communication port connected to the switch 200-3 (S13).

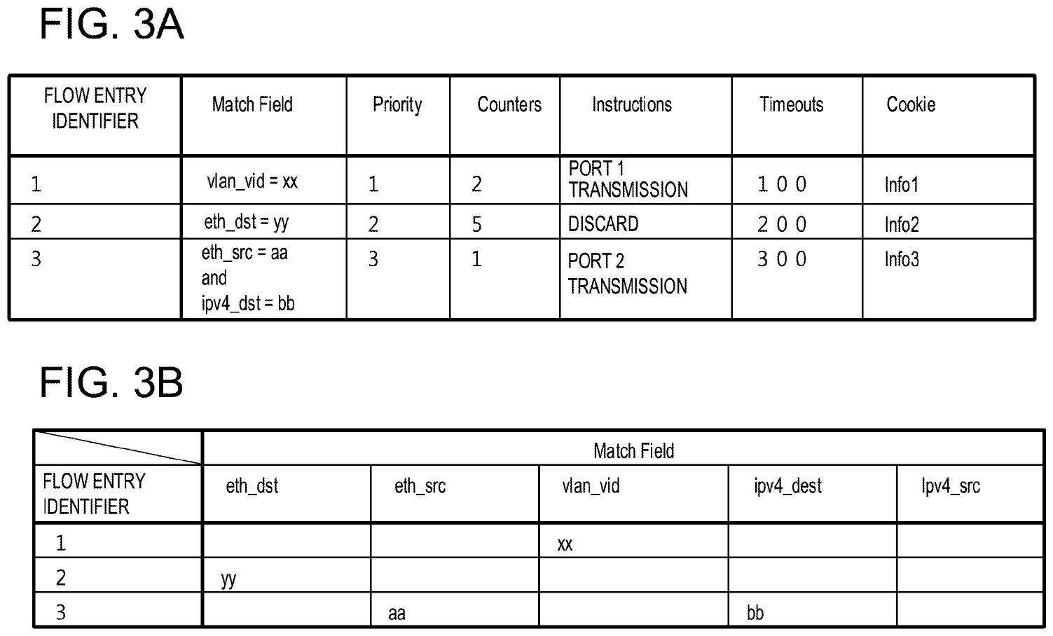

FIG. 3A is a diagram illustrating an example of a flow table possessed by the switch 200. The “flow entry identifier” section represents the number of each flow entry. Hereinafter, a flow entry whose number is n (n is an integer) may be referred to as a flow entry n.

The “Match Field” section indicates a condition of a packet that processes the flow entry. For example, the condition of the flow entry 1 indicates that a packet satisfying “vlan_vid=xx,” that is, a packet whose identifier of a virtual LAN (local area network) (VLAN) is xx, is to be processed. Further, for example, the condition of the flow entry 2 indicates that a packet satisfying “eth_dst=yy,” that is, a packet whose destination media access control (MAC) address of Ethernet (registered trademark) is yy, is to be processed. In addition, for example, the condition of the flow entry 3 indicates that a packet satisfying “eth_src=aa and ipv4_dst=bb,” that is, a packet whose transmission source MAC address of Ethernet, is aa, and destination IP address of Internet Protocol version 4 (IPv4) is bb, is to be processed.

Further, the match field may be stored as illustrated in FIG. 3B. The match field illustrated in FIG. 3B is the same as the match field illustrated in FIG. 3A. The match field illustrated in FIG. 3B indicates that the condition is, for example, an AND condition when conditions are stored in plural information elements as in the flow entry 3. In addition, the match field illustrated in FIG. 3B indicates that the condition is an OR condition when conditions are stored in plural information elements as in the flow entry 3.

The “Priority” section represents a priority order indicating which flow entry is processed when the packet matches the match field of plural flow entries. In the case of FIGS. 3A and 3B, since the priority of the flow entry 1 is 1, the priority of the flow entry 2 is 2, and the flow entry 3 is the priority 3, the process of the flow entry 1 is executed with the highest priority.

The “Counters” section is a counter section that counts the number of times that the flow entry is executed. The counter may be used to analyze trends and the like of packets that circulate in a communication system.

The “Instructions” section indicates a process for packets that match the match field of the flow entry. For example, the process in the flow entry 1 is “port 1 transmission,” which indicates that the received packet is transmitted to the port whose port number is 1. Further, for example, the flow entry 2 is “discard,” which indicates that the received packet is discarded without being transmitted.

The “Timeouts” section indicates an elapsed time since the flow entry is stored in the flow table. For example, when the unit of “Timeouts” is seconds, the flow entry 1 has passed 300 seconds since being stored in the flow table. Further, the “Timeouts” section indicates the elapsed time that has elapsed since the process of the flow entry was performed last time (i.e., since the packet that matches the match field of the flow entry was received last time).

In addition, the “Timeouts” section may indicate a predetermined time until the flow entry is deleted. For example, the switch 200 deletes the flow entry when the flow entry has not been executed for the predetermined time since the flow entry was stored in the previous execution or in the flow table.

The “Cookies” section indicates, for example, information used by the control device 300 and the switch 200. The “Cookies” section includes, for example, information on communication protocols and sessions.

<Configuration Example of Control Device>

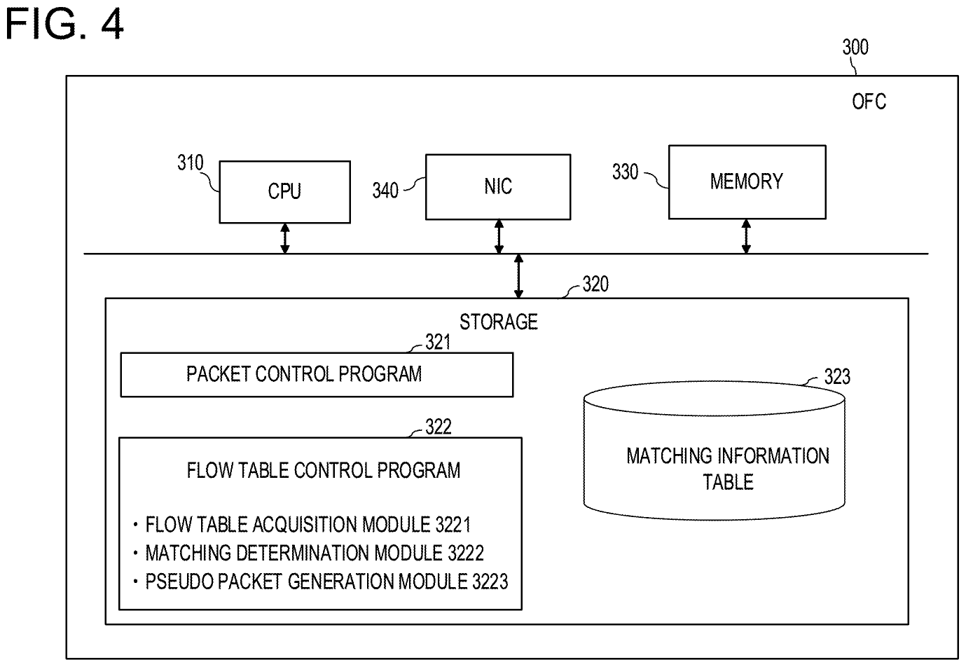

FIG. 4 is a diagram illustrating a configuration example of a control device 300. The control device 300 is, for example, an OFC, and includes a CPU 310, a storage 320, a memory 330, and a network interface card (NIC) 340.

The storage 320 is an auxiliary storage device such as a flash memory, a hard disk drive (HDD), or a solid state drive (SSD) that stores programs and data. The storage 320 includes a packet control program 321, a flow table control program 322, and a matching information table 323.

The memory 330 is an area that loads a program stored in the storage 320. In addition, the memory 330 is also used as an area where the program stores data.

The NIC 340 is an interface connected to the switch 200. The control device 300 communicates with the switch 200 by connecting the NIC 340 to the switch 200. The NIC 340 may connect, for example, a communication cable and a console cable. Further, the control device 300 may have, for example, NICs 340 according to the number of devices to be connected.

The CPU 310 is a processor that loads the program stored in the storage 320 into the memory 330, executes the loaded program, and implements each process.

The CPU 310 performs a packet control process by executing the packet control program 321. The packet control process is a process of responding to an inquiry (packet-in) from the switch 200, detecting a matching flow entry from, for example, the flow table of the master of the control device 300, and transmitting the detected flow entry to the switch 200.

By executing the flow table control program 322, the CPU 310 logically constructs an acquiring unit, an analyzing unit, and a generating unit, and performs a flow table control process. The flow table control process is a process of controlling the flow table included in the switch 200. In the flow table control process, the control device 300 performs a flow table acquisition process, a matching determination process, and a pseudo packet generation process.

Further, by executing a flow table acquisition module 3221 included in the flow table control program 322, the CPU 310 logically constructs the acquiring unit and performs the flow table acquisition process. The flow table acquisition process is a process of acquiring a flow table from the switch 200. In the flow table acquisition process, the control device 300 requests that the switch 200 transmit a flow table, and waits for the flow table to be transmitted from the switch 200. In the flow table acquisition process, when the flow table is transmitted from the switch 200, the control device 300 stores, for example, the acquired flow table in the internal memory in association with the identifier of the switch 200.

In addition, the CPU 310 executes a matching determination module 3222 included in the flow table control program 322, thereby constructing a generating unit and performing a matching determination process. The matching determination process is a process of comparing the flow table acquired from the switch 200 with the matching information table 323 and extracting a flow entry that matches the matching information table 323.

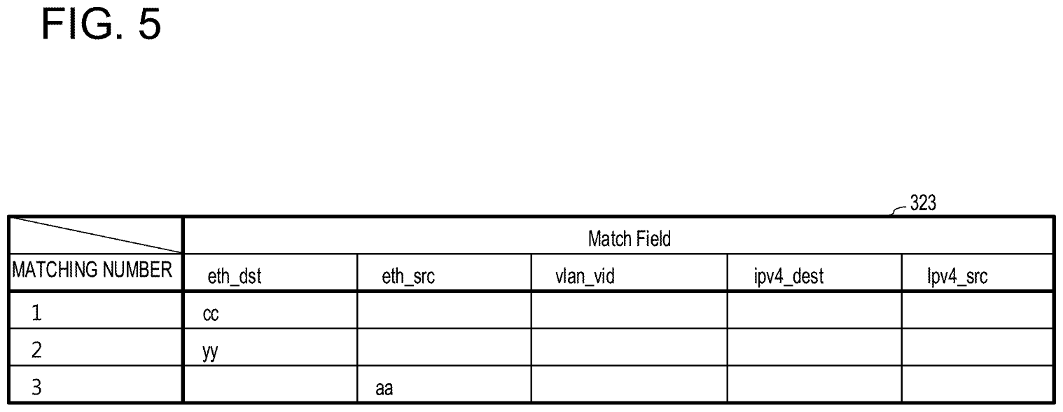

FIG. 5 is a diagram illustrating an example of a matching information table 323. The matching information table 323 includes the “Matching Number” section and the “Match Field” section. The “Matching Number” section is an identifier that indicates the number of the match field. The “Match Field” section is an information element used for verification as to whether there is a match with the match field of the flow entry of the flow table in the matching determination process described later. The information stored in the “Match Field” section is the same as the information illustrated in FIG. 3B.

The matching information table 323 is set by, for example, an administrator or a user of the communication system 10. The administrator specifies, for example, a flow entry of communication whose allowable delay time is a short time and sets the specified flow entry of communication in the matching information table 323. The administrator may prevent a flow entry from being deleted from the flow table by setting the flow entry of communication in which the allowable delay time is a short time in the matching information table 323, and suppress a delay in communication which becomes an object of the flow entry.

Further, by executing a pseudo packet generation module 3223 included in the flow table control program 322, the CPU 310 logically constructs the generating unit and a transmitting unit and performs the pseudo packet generation process. The pseudo packet generation process is a process of generating a pseudo packet corresponding to a flow entry that matches the flow table in the matching determination process and transmitting the generated pseudo packet to the switch 200 via the console cable.

<Flow Table Control Process>

The control device 300 performs the flow table control process. The flow table control process is a process of generating a pseudo packet corresponding to the flow entry so that a predetermined flow entry of the flow table of the switch 200 is not deleted, and transmitting the generated pseudo packet to the switch 200.

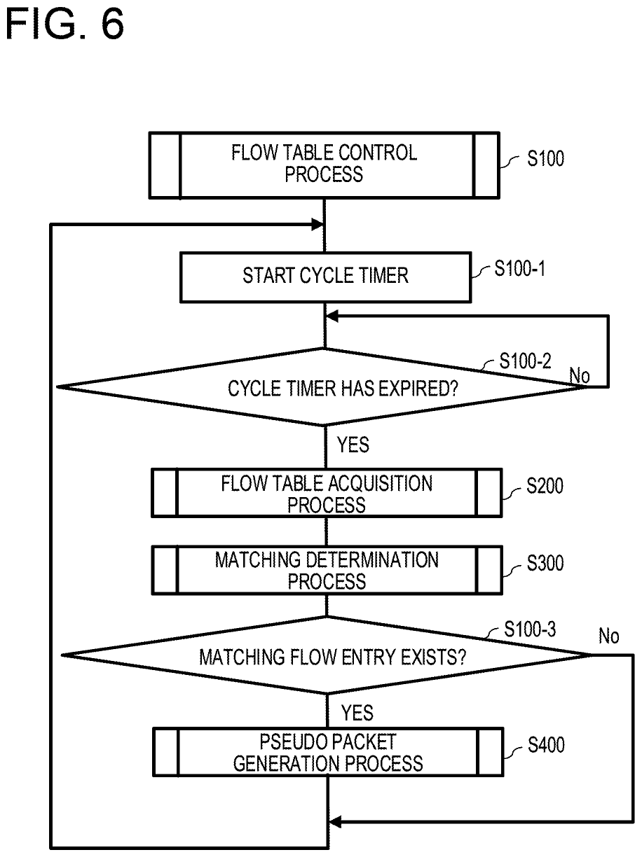

FIG. 6 is a diagram illustrating an example of a process flowchart of a flow table control process S100. In a flow table control process S100, the control device 300 starts a cycle timer (S100-1). The cycle timer is a timer that measures the period of performing the flow table control. The cycle timer is determined based on, for example, a deletion cycle at which the switch 200 deletes a flow entry from the flow table. The deletion cycle is the time when the switch 200 deletes a flow entry that has not been executed for a deletion time or longer from the flow table. The timer value of the cycle timer is, for example, a deletion cycle or a time which is slightly shorter than the deletion cycle (e.g., about 95% of the deletion cycle). By making the timer value of the cycle timer a time shorter than the deletion cycle, the control device 300 may transmit the pseudo packet before the switch 200 deletes the flow entry.

The control device 300 waits for the cycle timer to expire (timeout) (“No” in S100-2). When it is determined that the cycle timer times out (“Yes” in S100-2), the control device 300 performs a flow table acquisition process (S200). The flow table acquisition process S200 is a process of acquiring a flow table from the switch 200, and the details thereof will be described later.

Upon acquiring the flow table in the flow table acquisition process S200, the control device 300 performs a matching determination process (S300). A matching determination process S300 is a process of extracting a flow entry that matches the matching information table out of the flow entries of the flow table, and the details thereof will be described later.

When it is determined that there is a matching flow entry in the matching determination process S300 (“Yes” in S100-3), the control device 300 performs a pseudo packet generation process (S400). The pseudo packet generation process S400 is a process of generating a pseudo packet corresponding to a flow entry that matches in the matching determination process S300 and transmitting the generated pseudo packet to the switch 200, and the details thereof will be described later. Then, the control device 300 starts the cycle timer again (S100-1) and waits for expiration of the cycle timer (“No” in S100-2).

In the meantime, when it is determined that there is no matching flow entry in the matching determination process S300 (“No” in S100-3), the control device 300 starts the cycle timer again (S100-1) and waits for expiration of the cycle timer (“No” in S100-2).

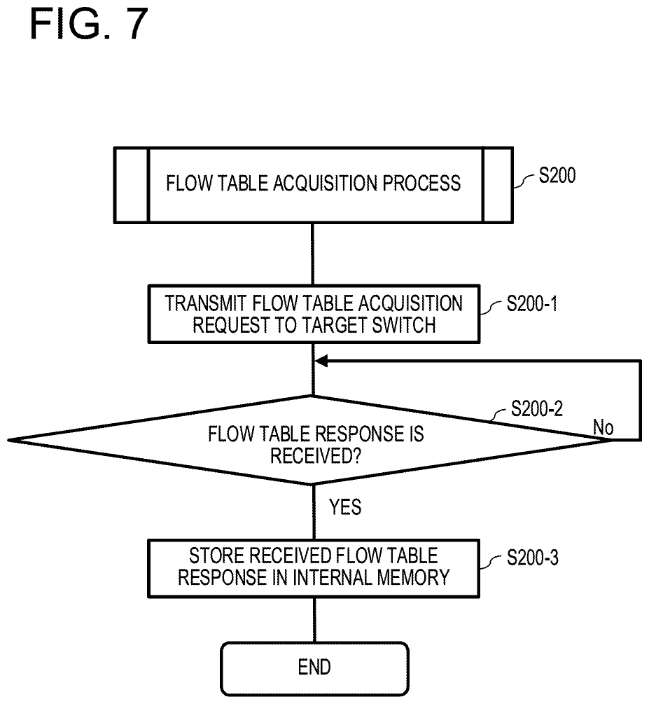

FIG. 7 is a diagram illustrating an example of a process flowchart of a flow table acquisition process S200. In the flow table acquisition process S200, the control device 300 transmits a flow table acquisition request to a target switch 200 (S200-1). The flow table acquisition request is a message requesting that the switch 200 transmit the flow table of the switch 200 to the control device 300.

The control device 300 waits to receive a flow table response from the switch 200 (“No” in S200-2). The flow table response is a message transmitted by the switch 200 in response to the flow table acquisition request and includes a flow table.

Upon receiving the flow table response (“Yes” in S200-2), the control device 300 stores the received flow table in the internal memory (S200-3), and ends the flow table acquisition process S200.

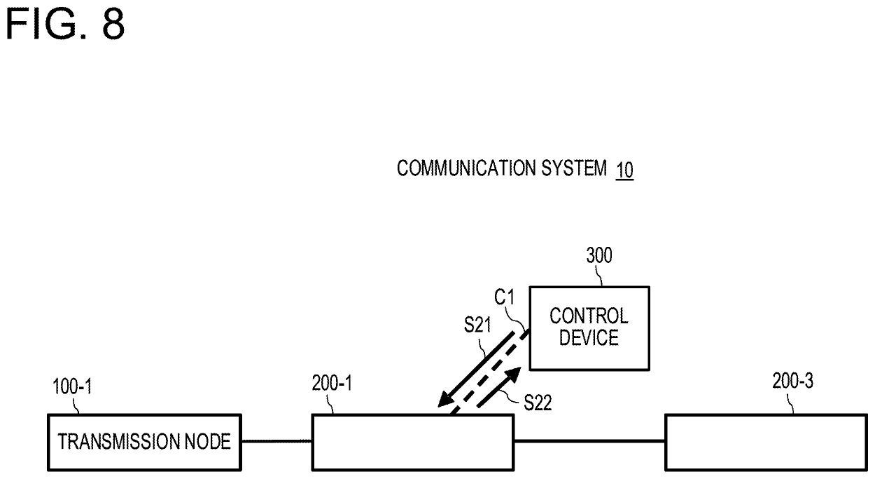

FIG. 8 is a diagram illustrating an example of a sequence of the flow table acquisition process S200. In the flow table acquisition process S200, the control device 300 transmits a flow table acquisition request to the switch 200-1 via the console cable C1 (S21 of FIG. 8 and S200-1 of FIG. 7).

In response to the flow table acquisition request, the switch 200-1 reads, for example, the flow table stored in the internal memory and transmits a flow table response including the read flow table to the control device 300 via the console cable C1 (S22).

Upon receiving the flow table response from the switch 200-1 via the console cable C1 (S22 of FIG. 8 and “Yes” in S200-2 of FIG. 7), the control device 300 stores the received flow table in the internal memory (S200-3 of FIG. 7), and ends the flow table acquisition process S200.

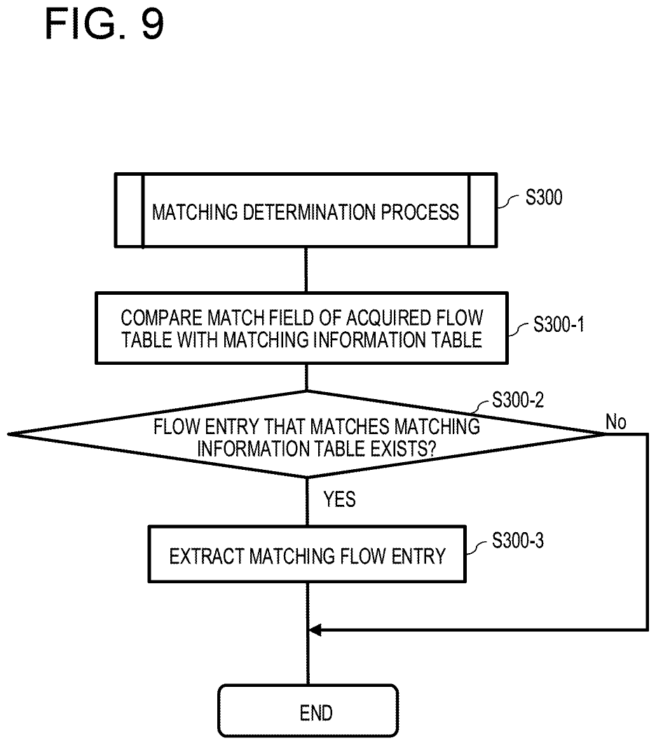

FIG. 9 is a diagram illustrating an example of a process flowchart of the matching determination process S300. In the matching determination process S300, the control device 300 compares the match field of the flow entry of the acquired flow table with the match field of the matching information table 323 (S300-1).

When it is determined that there is a flow entry that matches the match field in the matching information table 323 (“Yes” in S300-2), the control device 300 extracts the matching flow entry (S300-3), and ends the matching determination process S300.

In the meantime, when it is determined that there is no flow entry that matches the match field of the matching information table 323 (“No” in S300-2), the control device 300 ends the matching determination process S300.

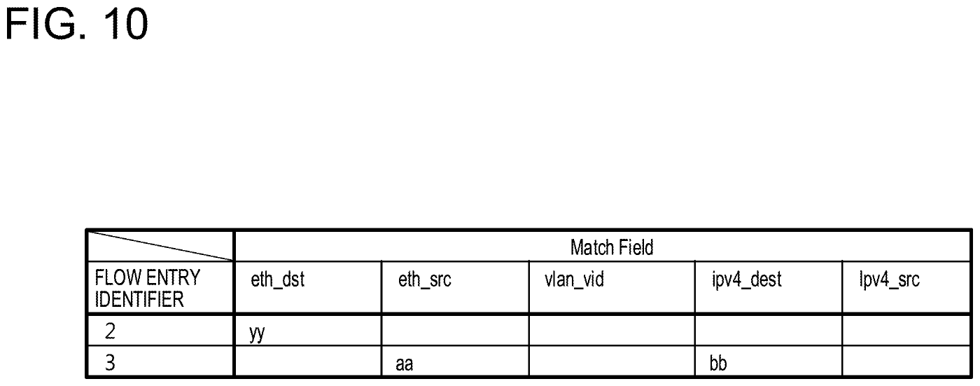

FIG. 10 is a diagram illustrating an example of a flow entry extracted in the matching determination process S300. In the matching determination process S300, the control device 300 compares the match field of the flow entry of the acquired flow table (e.g., FIG. 3B) with the match field of the matching information table 323 (e.g., FIG. 5) (S300-1 of FIG. 9).

Since it is determined that there is a flow entry that matches the match field in the matching information table 323 (“Yes” in S300-2 of FIG. 9), the control device 300 extracts the matched flow entry (S300-3 of FIG. 9). The match field of the matching number 2 in FIG. 5 matches the match field of the flow entry 2 in FIG. 3B, and the match field of the matching number 3 in FIG. 5 matches the match field of the flow entry 3 in FIG. 3B. Therefore, the control device 300 extracts the matched flow entries 2 and 3.

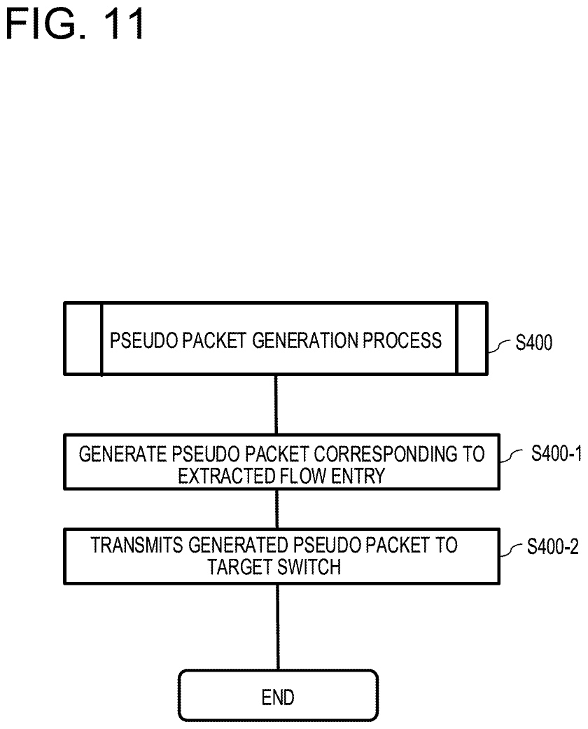

FIG. 11 is a diagram illustrating an example of a process flowchart of the pseudo packet generation process S400. In the pseudo packet generation process S400, the control device 300 generates a pseudo packet corresponding to the extracted flow entry (S400-1).

When generating the pseudo packet, the control device 300 determines an appropriate value for the information element which is not specified in the match field. Then, the control device 300 transmits the generated pseudo packet to the target switch (S400-2), and ends the process.

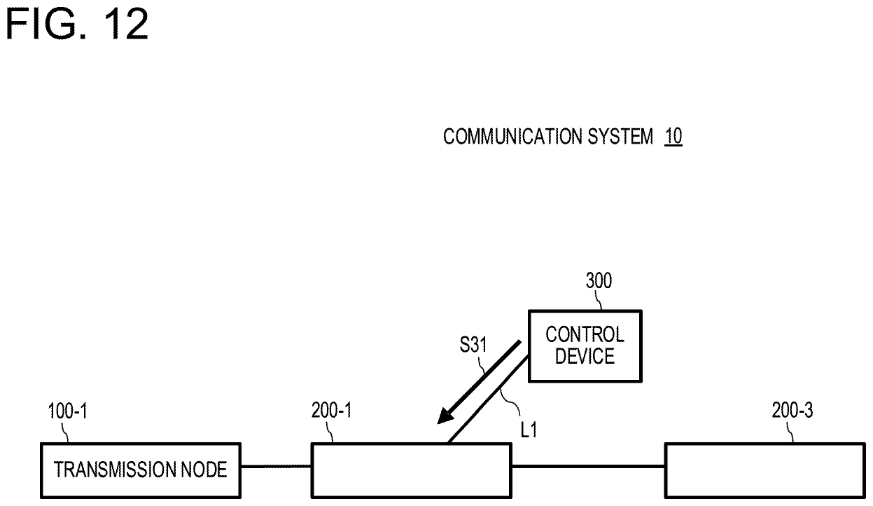

FIG. 12 is a diagram illustrating an example of a sequence of the pseudo packet generation process S400. In the pseudo packet generation process S400, the control device 300 generates a pseudo packet corresponding to the extracted flow entry (S400-1 of FIG. 11). When extracting the flow entry illustrated in FIG. 10, the control device 300 generates a pseudo packet corresponding to the flow entry 2 and a pseudo packet corresponding the flow entry 3, respectively.

When generating, for example, a pseudo packet corresponding to the flow entry 1, the control device 300 appropriately sets a transmission source MAC address of Ethernet, an identifier of the VLAN, a transmission source IP address of IPv4, and a destination IP address of IPv4 which are information elements other than the destination MAC address of Ethernet designated by the match field. The control device 300 sets, for example, the MAC address of its own device to the transmission source MAC address of Ethernet. Further, the control device 300 sets, for example, the IP address of its own device to the transmission source IP address of IPv4. In addition, the control device 300 sets, to the destination IP address of IPv4, a non-existing IP address or an IP address of the communication device that receives a similar packet to be discarded even when the similar packet is received.

It is preferable that the pseudo packet is a packet to be dropped at the destination, and for example, payloads other than the information elements designated by the match field may be all set to 0.

Then, the control device 300 transmits the two pseudo packets corresponding to the generated flow entries 2 and 3 to the switch 200-1 via a communication cable L1 (S31 of FIG. 12 and S400-2 of FIG. 11).

In the above-described example, descriptions have been made on a case where the control device 300 controls the flow table of the switch 200-1. However, the control device 300 also performs the flow table control process on the flow tables of the switches 200-2 and 200-3 other than the switch 200-1. In this case, the timer value of the cycle timer other than the switch 200-1 may be the same as or different from the timer value of the cycle timer in the flow table control process of the switch 200-1. Further, the matching information table used for the matching determination process may be prepared for each switch 200, and a different matching information table may be used for each switch 200.

In the first embodiment, the control device 300 generates a pseudo packet corresponding to a flow entry that matches the matching information table, and transmits the generated pseudo packet to the switch 200. As a result, the switch 200 may maintain the flow entry without deleting the flow entry, and may process the packet corresponding to the flow entry without inquiring of the control device 300 when such a packet is received. The switch 200 may suppress the transmission delay of the packet corresponding to the flow entry by processing the packet without inquiring of the control device 300.

### Second Embodiment

Next, a second embodiment will be described. In the second embodiment, the control device 300 further performs a continuation determination. In the continuation determination, the control device 300 does not generate a pseudo packet for a flow entry that has not been executed for a predetermined time.

<Configuration Example of Control Device>

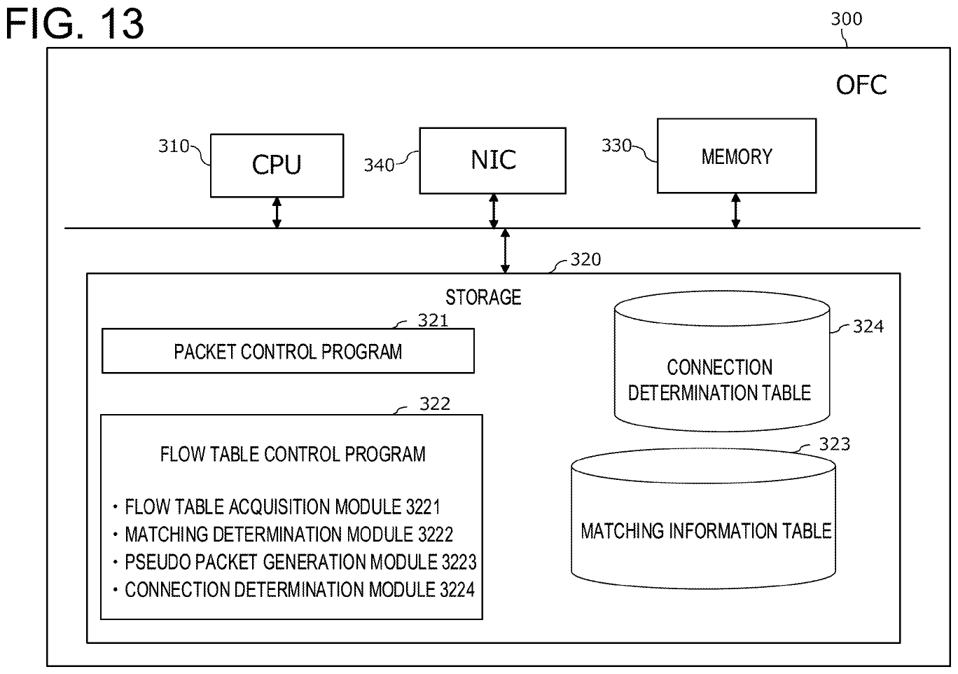

FIG. 13 is a diagram illustrating a configuration example of a control device 300. The control device 300 includes a CPU 310, a storage 320, a memory 330, and an NIC 340.

The storage 320 is an auxiliary storage device such as a flash memory, an HDD, or an SSD that stores programs and data. The storage 320 includes a packet control program 321, a flow table control program 322, a matching information table 323, and a continuation determination table 324.

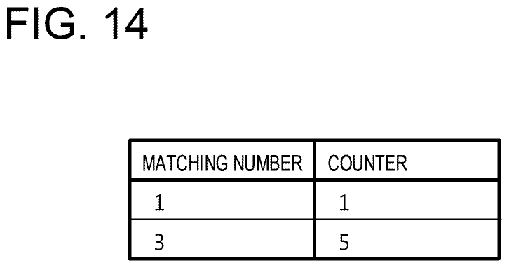

FIG. 14 is a diagram illustrating an example of the continuation determination table 324. The continuation determination table 324 includes a “Matching Number” section and a “Counter” section. The “Matching Number” section indicates the matching number of the matching information table 323. Further, in the continuation determination table 324, the matching number may be replaced with a flow entry number.

The “Counter” section indicates the number of consecutive execution times of generation of pseudo packet, and, for example, the initial value is 0. The counter indicates the number of generation times of pseudo packet, for example, since a flow entry corresponding to the matching number was executed last time, or since a flow entry corresponding to the matching number was stored in the flow table.

The CPU 310 executes the flow table control program 322 to perform the flow table control process. The flow table control process is a process of controlling the flow table included in the switch 200. In the flow table control process, the control device 300 performs the flow table acquisition process, the matching determination process, the pseudo packet generation process, and the continuation determination process.

Further, the CPU 310 executes the continuation determination process by executing a continuation determination module 3224 included in the flow table control program 322. The continuation determination process is a process of determining whether to continue to store the flow entry in the flow table, that is, whether to generate a pseudo packet of the flow entry. In the continuation determination process, the control device 300 refers to the continuation determination table 324, and when it is determined that the flow entry has not been executed for a predetermined period other than the pseudo packet, the control device 300 does not generate the pseudo packet of the flow entry.

The other processes of the CPU 310, the memory 330, and the NIC 340 are the same as those of the CPU 310, the memory 330, and the NIC 340 illustrated in FIG. 4.

<Flow Table Control Process>

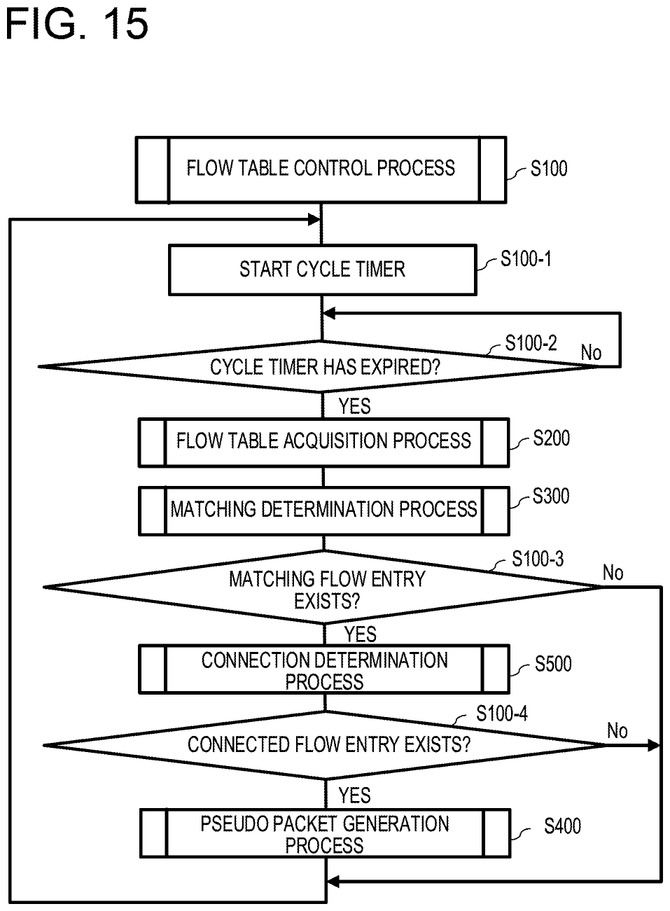

FIG. 15 is a diagram illustrating an example of a process flowchart of a flow table control process S100 according to a second embodiment. The processes S100-1 to S100-3, the flow table acquisition process S200, the matching determination process S300, and the pseudo packet generation process S400 in FIG. 15 are the same as the processes S100-1 to S100-3, the flow table acquisition process S200, the matching determination process S300, and the pseudo packet generation process S400 in FIG. 6, respectively.

When it is determined that there is a flow entry that matches in the matching determination process S300 (“Yes” in S100-3), the control device 300 performs a continuation determination process (S500). The continuation determination process S500 is a process of determining whether to generate a pseudo packet for the flow entry that matches in the matching determination process S300, and the details thereof will be described later.

When it is determined that a flow entry is continued (“Yes” in S100-4), the control device 300 performs a pseudo packet generation process S400, and ends the flow table control process S100. In the meantime, when it is determined that the continued flow entry does not exist (“No” in S100-4), the control device 300 ends the flow table control process S100.

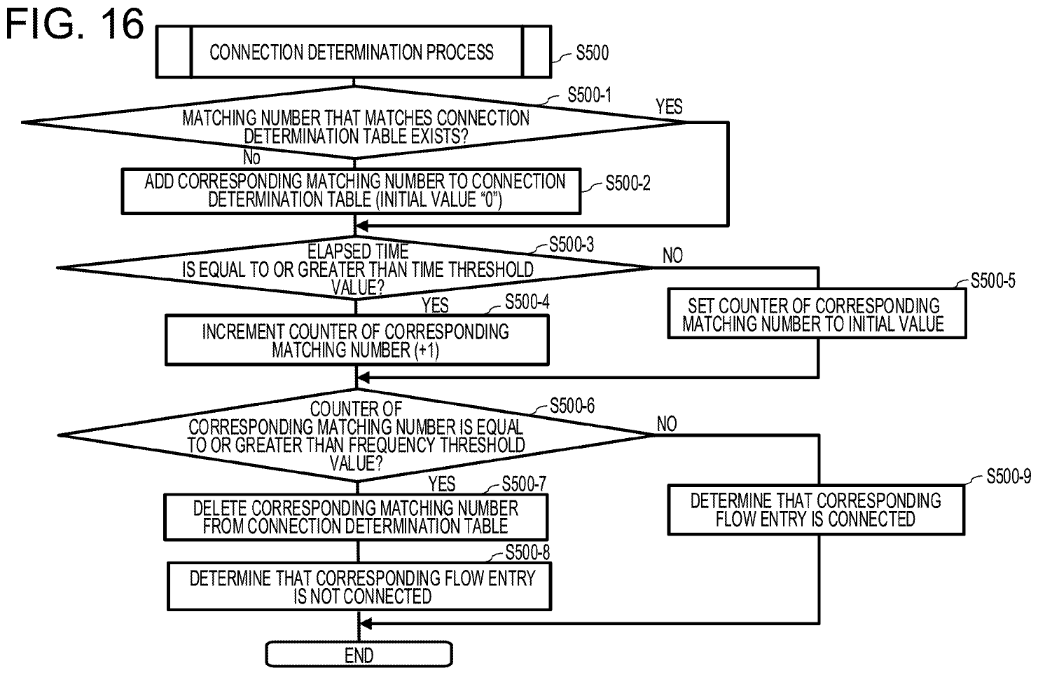

FIG. 16 is a diagram illustrating an example of a process flowchart of the continuation determination process S500. The control device 300 confirms whether the matching number corresponding to the flow entry that matches in the matched matching determination process S300 exists in the continuation determination table (S500-1). When it is determined that the matching number does not exist in the continuation determination table 324 (“No” in S500-1), the control device 300 adds the matching number to the continuation determination table 324 (S500-2). In the process S500-2, the control device 300 sets the counter of the matching number to 0, which is an initial value. In the meantime, when it is determined that the matching number exists in the continuation determination table 324 (“Yes” in S500-1), the control device 300 performs the next process S500-3 without performing the process S500-2.

Then, the control device 300 confirms the elapsed time of the flow entry (S500-3). The elapsed time is, for example, the “timeouts” of the flow entry. When it is determined that the elapsed time of the flow entry is equal to or greater than a time threshold value (“Yes” in S500-3), the control device 300 increments the counter of the matching number (S500-4). In the meantime, when it is determined that the elapsed time of the flow entry is less than the time threshold value (“No” in S500-3), the control device 300 sets the counter of the matching number to the initial value (e.g., 0) (S500-5).

The time threshold value (second time) is determined based on, for example, the timer value of the cycle timer. The time threshold value is, for example, a timer value of the cycle timer. Further, the time threshold value may be a value which is close to the timer value of the cycle timer (e.g., a value of 95% to 105% of the timer value). By determining the time threshold value based on the timer value of the cycle timer, the control device 300 may confirm whether the flow entry is being executed by using other than the pseudo packet.

Then, the control device 300 confirms whether the counter of the matching number is equal to or greater than a frequency threshold value (S500-6). When it is determined that the counter of the matching number is less than the frequency threshold value (“No” in S500-6), the control device 300 determines that the flow entry is continued (S500-9), and ends the process. In the meantime, when it is determined that the counter of the matching number is equal to or greater than the frequency threshold value (“Yes” in S500-6), the control device 300 deletes the matching number from the continuation determination table 324 (S500-7), determines that the flow entry is not continued (S500-8), and ends the process. The control device 300 may determine that the switch 200 has not received a packet corresponding to the flow entry with packets other than the pseudo packet for a first time by appropriately setting the frequency threshold value (e.g., a third value). Then, the switch 200 may delete the flow entry.

FIG. 14 is a diagram illustrating an example of the continuation determination table 324. Hereinafter, descriptions will be made on a case where the continuation determination table 324 before execution of the continuation determination process S500 is in the state illustrated in FIG. 14. In the meantime, it is assumed that the flow table is as illustrated in FIG. 3, and the flow entry extracted by the control device 300 is as illustrated in FIG. 10. Further, the time threshold value is assumed to be 300 seconds. The frequency threshold value is also assumed to be six times.

First, the flow entry 2 (matching number 2) of the extracted flow entry will be described. Since it is determined that the matching number 2 does not exist in the continuation determination table 324 (“No” in S500-1 of FIG. 16), the control device 300 continues to add the matching number 2 and the initial value 0 of the counter to the continuation determination table 324 (S500-2 of FIG. 16). Since the elapsed time of the flow entry 2 is 200 from FIG. 13, which is less than the time threshold value (300) (“No” in S500-3 of FIG. 16), the control device 300 sets the counter of the matching number 2 to the initial value 0 (S500-5 of FIG. 16). Then, the control device 300 determines that the counter of the matching number 2 is 0 and is less than the frequency threshold value (6) (“No” in S500-6 of FIG. 16), and determines that the flow entry 2 is continued (S500-9 of FIG. 16).

Since it is determined that the flow entry 2 is continued (“Yes” in S100-4 of FIG. 15), the control device 300 generates a pseudo packet of the flow entry 2 and transmits the generated pseudo packet to the switch 200-1 (S400 of FIG. 15).

Next, the flow entry 3 (matching number 3) of the extracted flow entry will be described. The control device 300 determines that the matching number 3 exists in the continuation determination table 324 (“Yes” in S500-1 of FIG. 16). Then, since the elapsed time of the flow entry 3 is 300 from FIG. 13, which is equal to or greater than the time threshold value (300) (“Yes” in S500-3 of FIG. 16), the control device 300 increments the counter of the matching number 3 and sets the counter of the matching number 3 to 6 (S500-4 of FIG. 16). Then, the control device 300 determines that the counter of the matching number 3 is 6 and is equal to or greater than the frequency threshold value (6) (“Yes” in S500-6 of FIG. 16), deletes the matching number 3 from the continuation determination table 324, and determines that the flow entry 3 is not continued (S500-8 of FIG. 16).

Since it is determined that the flow entry 3 is not continued (“No” in S100-4 of FIG. 15), the control device 300 ends the flow table control process S100 without generating a pseudo packet of the flow entry 3.

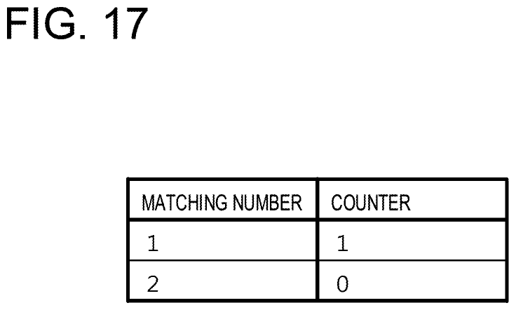

FIG. 17 is a diagram illustrating an example of the continuation determination table 324 after execution of the continuation determination process S500. As described above, in the continuation determination table 324, the matching number 2 is added, and the counter becomes 0 which is the initial value. Further, in the continuation determination table 324, the matching number 3 is deleted.

In the second embodiment, the control device 300 controls the flow entry which has not been executed for a predetermined time to be deleted from the flow table by not generating a pseudo packet. As a result, a flow entry which has not been executed for a predetermined time is suppressed from being stored for a long time in the flow table, and the memory of the switch 200 may be efficiently used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
acquiring, from a switch, a flow table that includes flow entries each including a match field that defines processing for a packet and includes at least a destination address;
extracting a flow entry that is included in the acquired flow table and includes a match field that matches a match field of an entry of matching information stored in advance in a memory;
generating a pseudo packet corresponding to the extracted flow entry; and
transmitting the generated pseudo packet to the switch.

2. The non-transitory computer-readable recording medium according to claim 1, the process further comprising:
acquiring the flow table at every predetermined cycle time.

3. The non-transitory computer-readable recording medium according to claim 2, the process further comprising:
suspending the generation of the pseudo packet when it is determined that the switch does not receive a packet other than the pseudo packet during a first amount of time.

4. The non-transitory computer-readable recording medium according to claim 3, wherein
the flow table includes information indicating an elapsed time elapsed since each of the flow entries is previously executed, and
the process further comprises:
incrementing a counter when an elapsed time of the extracted flow entry is equal to or greater than a second amount of time;
resetting the counter when the elapsed time of the extracted flow entry is less than the second amount of time; and
determining that the switch does not receive the packet other than the pseudo packet during the first amount of time when the counter is equal to or greater than a predetermined value.

5. The non-transitory computer-readable recording medium according to claim 2, wherein
the cycle time is determined based on a reference time for determining whether to delete a flow entry from the flow table.

6. The non-transitory computer-readable recording medium according to claim 4, wherein
the second amount of time is determined based on the cycle time.

7. The non-transitory computer-readable recording medium according to claim 1, wherein
the computer and the switch are included in a communication system which conforms to an open flow protocol,
the switch includes an open flow switch, and
the computer includes an open flow controller.

8. The non-transitory computer-readable recording medium according to claim 1, the process further comprising:
requesting the switch to transmit the flow table; and
receiving a response including the flow table from the switch.

9. The non-transitory computer-readable recording medium according to claim 1, wherein
the computer is connected to the switch by a control connection for controlling the switch and is connected to the switch by a communication connection for communicating with the switch, and
the process further comprises:
transmitting the generated pseudo packet using the communication connection.

10. A control device, comprising:
a processor configured to:
acquire, from a switch, a flow table that includes flow entries each including a match field that defines processing for a packet and includes at least a destination address;
extract a flow entry that is included in the acquired flow table and includes a match field that matches a match field of an entry of matching information stored in advance in a memory;
generate a pseudo packet corresponding to the extracted flow entry; and
transmit the generated pseudo packet to the switch.

11. A control method, comprising:
acquiring by a computer, from a switch, a flow table that includes flow entries each including a match field that defines processing for a packet and includes at least a destination address;
extracting a flow entry that is included in the acquired flow table and includes a match field that matches a match field of an entry of matching information stored in advance in a memory;
generating a pseudo packet corresponding to the extracted flow entry; and
transmitting the generated pseudo packet to the switch.
